(19) United States
(12) Patent Application Publication
(10) Pub. No.: US 2026/0018956 A1
(43) Pub. Date: Jan. 15, 2026

(54) CLUSTER BLOCK FIXING STRUCTURE, ELECTRIC MOTOR TO WHICH CLUSTER BLOCK IS MOUNTED BY THE CLUSTER BLOCK FIXING STRUCTURE, ELECTRIC COMPRESSOR HAVING CLUSTER BLOCK FIXING STRUCTURE, AND AIR-CONDITIONING APPARATUS, REFRIGERATOR, AND ON-VEHICLE APPARATUS HAVING THE ELECTRIC COMPRESSOR MOUNTED THERETO

(71) Applicant: AICHI ELECTRIC CO., LTD., Kasugai city (JP)

(72) Inventors: Yudai Suzuki, Kasugai city (JP); Masashi Kuroko, Kasugai city (JP); Takashi Hori, Kasugai city (JP)

(73) Assignee: AICHI ELECTRIC CO., LTD., Kasugai city (JP)

(21) Appl. No.: 19/267,770

(22) Filed: Jul. 14, 2025

(30) Foreign Application Priority Data
Jul. 15, 2024 (JP) 2024-113019

(51) Int. Cl. H02K 3/52; B60H 1/32; F25B 31/02

(52) U.S. Cl. CPC H02K 3/522; B60H 1/3204; F25B 31/02; H02K 2203/06; H02K 2203/12

(57) ABSTRACT

To provide a cluster block fixing structure that allows a cluster block to be easily mounted to a bobbin and simultaneously makes detachment of the cluster block difficult after the cluster block has been mounted, and the like. A cluster block includes a second plate portion in contact with a bobbin, a first through hole penetrating through the second plate portion, and a wall portion having a regulation surface facing toward the first through hole and protruding from the second plate portion. The bobbin includes a protrusion to be inserted into the first through hole, and a projection projecting from the end of the protrusion in the same direction as a direction in which the regulation surface faces. The second plate portion and the projection oppose each other in a state where the contact surface of the bobbin is in contact with the regulation surface.

### BACKGROUND OF THE INVENTION

### 1. Field of the Invention

The present invention relates to a cluster block fixing structure that allows a cluster block to be easily mounted to a bobbin of an electric motor and simultaneously makes detachment of the cluster block difficult after the cluster block has been mounted, an electric motor to which the cluster block is mounted by the cluster block fixing structure, an electric compressor having the cluster block fixing structure, and an air-conditioning apparatus, a refrigerator, and an on-vehicle apparatus having the electric compressor mounted thereto.

### 2. Description of the Related Art

An electric compressor mounted to an air-conditioning apparatus, a refrigerator, an on-vehicle apparatus, or the like mainly includes a compressing portion for compressing a fluid, an electric motor for driving the compressing portion, a control circuit for performing drive control of the electric motor, motor wiring extracted from the electric motor, a connection terminal disposed at the end of the motor wiring and electrically connected to the control circuit, and an insulating cluster block for storing the connection terminal. The electric motor includes a cylindrical stator core, a cylindrical bobbin disposed on the end surface of the stator core in the axial direction, and a coil wound around the bobbin.

In the electric compressor disclosed in International Publication No. WO2023/189893, for bringing a cluster block 120 into contact with an end surface of an insulator 112 (bobbin) in the axial direction and positioning the cluster block 120 in the circumferential direction, a detachable holding tool 150 is fitted into an inner circumferential surface 111d of a stator core 111, and a fitting portion 125 of the cluster block 120 is fitted into the holding tool 150. By connecting a control unit 140 (control circuit) to a connection terminal 116 in the cluster block 120, the cluster block 120 is fixed to a motor 100 (electric motor), and therefore, the holding tool 150 is detached from the stator core 111 and the fitting portion 125 after the cluster block 120 has been fixed.

It is considered that, in the technique disclosed in International Publication No. WO2023/189893, the cluster block is directly mounted to the bobbin in order to reduce the number of mounting steps and the number of components. However, in International Publication No. WO2023/189893, the fitting portion 125 is lightly press-fitted to the holding tool 150 in the axial direction and thus fitted, and therefore, if the interference is small in the press-fitting, the fitting portion 125 is likely to be detached, and if the interference is large, press-fitting of the fitting portion 125 may become difficult, and mountability of the cluster block 120 may be degraded. Therefore, even if the cluster block is attempted to be directly mounted to the bobbin by the mounting method described in International Publication No. WO2023/189893, it is difficult to easily mount the cluster block and simultaneously make detachment of the cluster block difficult after the cluster block has been mounted.

### SUMMARY OF THE INVENTION

The present invention has been made in order to solve the aforementioned problem, and an object of the present invention is to provide a cluster block fixing structure that allows a cluster block to be easily mounted to a bobbin and simultaneously makes detachment of the cluster block difficult after the cluster block has been mounted, an electric motor to which the cluster block is mounted by the cluster block fixing structure, an electric compressor having the cluster block fixing structure, and an air-conditioning apparatus, a refrigerator, and an on-vehicle apparatus having the electric compressor mounted thereto.

In order to attain the object, a cluster block fixing structure of the present invention is directed to a structure for mounting a cluster block to an electric motor in an electric compressor that includes a compressing portion for compressing a fluid, the electric motor for driving the compressing portion, a control circuit for performing drive control of the electric motor, a motor wire extracted from the electric motor, a connection terminal disposed at an end of the motor wire and electrically connected to the control circuit, and an insulating cluster block for storing the connection terminal. The electric motor includes a cylindrical bobbin which is disposed on an axial end surface of a cylindrical stator core and around which a coil is wound. The cluster block includes a bottom plate having a bottom surface in contact with an axial end surface of the bobbin on an opposite side to the stator core side, a first through hole penetrating through the bottom plate in an axial direction of the bobbin, and a wall portion having a regulation surface facing toward the first through hole, the wall portion extending toward the stator core from the bottom surface. The bobbin includes a protrusion protruding from the axial end surface of the bobbin, the protrusion being inserted into the first through hole, a projection projecting from an end of the protrusion in a direction that is the same as a direction in which the regulation surface faces, and a contact surface coming into contact with the regulation surface. A part of the bottom plate around the first through hole and the projection oppose each other in the axial direction in a state where the contact surface is in contact with the regulation surface.

In the cluster block fixing structure according to a first aspect, the protrusion of the bobbin is inserted into the first through hole that penetrates through the bottom plate of the cluster block, and thus, movement of the cluster block relative to the bobbin in the directions other than the axial direction is basically regulated. Furthermore, since a part of the bottom plate around the first through hole and the projection oppose each other (are caught) in the axial direction, movement of the cluster block relative to the bobbin in the axial direction is also regulated. Even if the bottom plate is attempted to be relatively moved in the projecting direction of the projection so as to release the opposing, the relative movement is regulated by the contact between the regulation surface and the contact surface, and releasing of the opposing can be inhibited. As a result, the cluster block can be made unlikely to be detached from the bobbin.

Meanwhile, when the cluster block is mounted to the bobbin, the projection and the protrusion are firstly inserted into the first through hole in a state where the bottom plate is inclined such that the wall portion side portion of the bottom plate is away from the bobbin. Thereafter, the wall portion side portion of the bottom plate is inclined by using the first through hole as a pivot, and the regulation surface is caused to oppose the contact surface while the bottom surface of the bottom plate is brought into contact with the axial end surface of the bobbin, and thus, the cluster block can be easily mounted. As a result, the cluster block can be easily mounted to the bobbin, and simultaneously, detachment of the cluster block can be made difficult after the cluster block has been mounted.

In the cluster block fixing structure according to a second aspect, in addition to the effect exhibited by the cluster block fixing structure according to the first aspect, the following effect is exhibited. Since the motor wire extending from the cluster block is curved along a circumferential direction of the bobbin, a force is applied to the cluster block toward the outer side in the radial direction relative to the electric motor due to an elastic reaction force of the motor wire. The contact surface is an inner circumferential wall surface facing inward in the radial direction in the bobbin. Therefore, the regulation surface of the cluster block is pressed against the contact surface due to the elastic reaction force. Thus, contact between the contact surface and the regulation surface can be easily maintained due to the elastic reaction force, and accuracy for positioning the cluster block relative to the bobbin in the radial direction can be enhanced.

In the cluster block fixing structure according to a third aspect, in addition to the effect exhibited by the cluster block fixing structure according to the first aspect, the following effect is exhibited. A projection length of the projection from the protrusion to an end of the projection is half or more a thickness in dimensions of the protrusion in the first through hole in a projecting direction of the projection. Thus, by ensuring the projection length, opposing of the bottom plate and the projection can be inhibited from being released due to the projection being disengaged from the first through hole, and the cluster block can be made more unlikely to be detached from the bobbin.

In the cluster block fixing structure according to a fourth aspect, in addition to the effect exhibited by the cluster block fixing structure according to the first aspect, the following effect is exhibited. The cluster block includes a second through hole penetrating through the bottom plate in the axial direction at a position which is distant from the first through hole in a direction perpendicular to the projecting direction of the projection. An insertion portion protruding from the axial end surface of the bobbin is inserted into the second through hole. After the insertion portion is inserted to mount the cluster block, even if the cluster block is attempted to be inclined merely in the projecting direction of the projection by using the first through hole as a pivot, the bottom plate around the second through hole and the insertion portion interfere with each other, and the inclination is difficult. Meanwhile, in a case where the linear line portion connecting the wall portion and the second through hole to each other is inclined so as to be lifted by using the first through hole as a pivot, the cluster block can be easily detached from the bobbin, and the cluster block can be easily mounted to the bobbin. Therefore, in a case where an operator knows the method for mounting the cluster block, reduction of the mountability can be inhibited, and furthermore, the cluster block can be inhibited from being unintentionally detached since the detachment method is limited.

In the cluster block fixing structure according to a fifth aspect, in addition to the effect exhibited by the cluster block fixing structure according to the fourth aspect, the following effect is exhibited. Since the motor wire extending from the cluster block is curved along a circumferential direction of the bobbin, a force is applied to the cluster block toward the outer side in the radial direction relative to the electric motor due to an elastic reaction force of the motor wire. The contact surface is an inner circumferential wall surface facing inward in the radial direction in the bobbin. Therefore, the regulation surface of the cluster block is pressed against the contact surface due to the elastic reaction force. Thus, contact between the contact surface and the regulation surface can be easily maintained due to the elastic reaction force, and accuracy for positioning the cluster block relative to the bobbin in the radial direction can be enhanced.

The bottom plate around the first through hole is formed by a hook portion by opening a part of the first through hole on an outer side in the radial direction at an edge of the bottom plate on an outer side in the radial direction. When the cluster block is mounted, the insertion portion is firstly inserted into the second through hole such that the hook portion is positioned inward of the protrusion in the radial direction, and the bottom surface of the bottom plate is brought into contact with the axial end surface of the bobbin. Thereafter, the hook portion is rotated around the insertion portion, and the hook portion is caught by the protrusion, and thus, the cluster block can be easily mounted to the bobbin.

An electric motor according to a sixth aspect, an electric compressor according to a seventh aspect, an air-conditioning apparatus according to an eighth aspect, a refrigerator according to a ninth aspect, and an on-vehicle apparatus according to a tenth aspect each include the cluster block fixing structure according to any one of the first to the fifth aspects, and each have the effect exhibited by the cluster block fixing structure.

### BRIEF DESCRIPTION OF THE DRAWINGS

FIG. 1A is a block diagram schematically illustrating a vehicle to which an electric compressor according to a first embodiment is mounted.

FIG. 1B is a cross-sectional view schematically illustrating the electric compressor.

FIG. 2 is a half sectional view of the electric compressor at a line II-II in FIG. 1B.

FIG. 3 is a perspective view of the electric compressor in which a portion near a connector including a cluster block is enlarged.

FIG. 4 is an exploded perspective view of the connector as viewed from the upper side.

FIG. 5 is an exploded perspective view of the connector as viewed from the lower side.

FIG. 6A is a cross-sectional view of the connector at a line VIa-VIa in FIG. 2.

FIG. 6B is a cross-sectional view of the connector at a line VIb-VIb in FIG. 6A.

FIG. 7A is a cross-sectional view of the connector at a line VIIa-VIIa in FIG. 2.

FIG. 7B is a cross-sectional view of the connector at a line VIIb-VIIb in FIG. 2.

FIG. 8A is a top view of the electric compressor according to a second embodiment.

FIG. 8B is a perspective view of the connector.

FIG. 9A is a perspective view of a cluster block according to a third embodiment.

FIG. 9B is a perspective view of a cluster block according to a fourth embodiment.

FIG. 10A is a block diagram schematically illustrating an air-conditioning apparatus having the electric compressor mounted thereto.

FIG. 10B is a block diagram schematically illustrating a refrigerator having the electric compressor mounted thereto.

FIG. 11A is a top view of a cluster block according to a modification.

FIG. 11B is a bottom view of the cluster block according to the modification.

### DESCRIPTION OF THE PREFERRED EMBODIMENTS

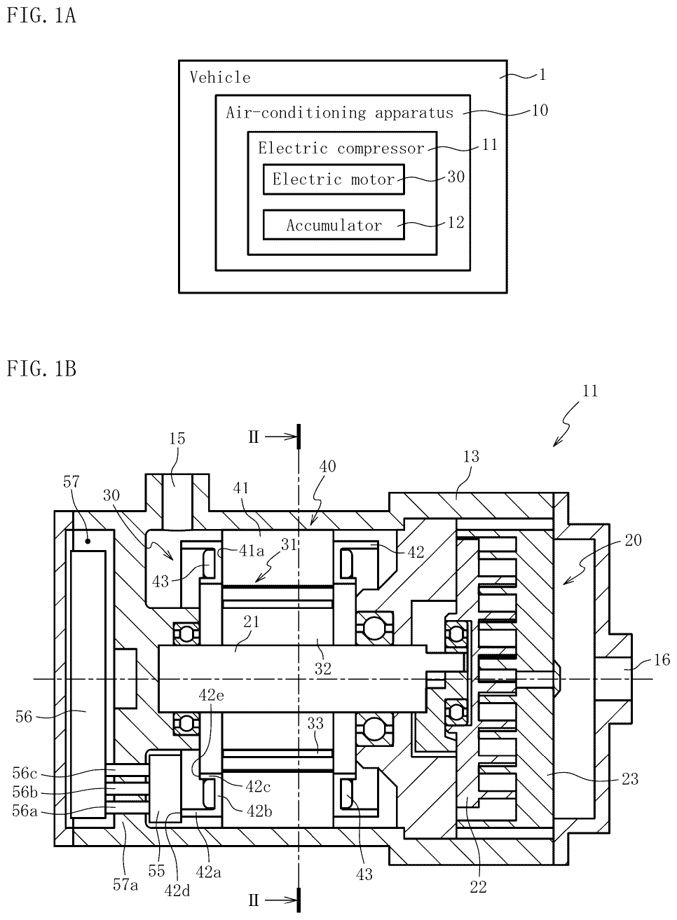

Preferred embodiments will be described below with reference to the accompanying drawings. FIG. 1A is a block diagram schematically illustrating a vehicle 1 having an air-conditioning apparatus 10 to which an electric compressor 11 according to a first embodiment is mounted. FIG. 1B is a cross-sectional view schematically illustrating the electric compressor 11. In FIG. 1B, hatching of some (rotor 31, stator 40, and the like) of parts of the electric compressor 11 is omitted for simplifying the drawing.

As shown in FIG. 1A and FIG. 1B, the air-conditioning apparatus 10 (on-vehicle apparatus) of the vehicle 1 is an apparatus for sending cool air generated by the electric compressor 11 to an inner space of the vehicle 1. The electric compressor 11 mainly includes a compressing portion 20, an electric motor 30, and an accumulator 12. The compressing portion 20 and the electric motor 30 are disposed in a sealed container 13. In the sealed container 13, a suction tube 15 and a discharge tube 16 that connect between the outside and the inside of the sealed container 13 are disposed.

The accumulator 12 is for separating lubricating oil and a cooling medium (for example, cooling gas) as a fluid from each other. The cooling medium separated by the accumulator 12 is returned through the suction tube 15 to the compressing portion 20. The lubricating oil separated by the accumulator 12 is returned into a lubricating oil reservoir in the sealed container 13. The air-conditioning apparatus 10 may include a receiver for storing compressed cooling medium in addition to the accumulator 12 or instead of the accumulator 12.

The compressing portion 20 includes a rotation shaft 21, an orbiting scroll 22 driven by the electric motor 30 through the rotation shaft 21, and a fixed scroll 23 fixed to the sealed container 13. The rotation shaft 21 is a rod-like member that rotates around an axis C that is the axis of the rotation shaft 21. The compressing portion 20 rotates the orbiting scroll 22 around the axis C to turn the orbiting scroll 22, and compresses the cooling medium suctioned through the suction tube 15 between a spiral wrap disposed in the orbiting scroll 22, and a spiral wrap disposed in the fixed scroll 23 so as to mate with the spiral wrap disposed in the orbiting scroll 22. Hereinafter, the axial direction of the axis C is referred to as “axis C direction”, the direction orthogonal to the axis C is referred to as “radial direction”, and the direction around the axis C is referred to as “circumferential direction”.

The cooling medium compressed by the compressing portion 20 is discharged through the discharge tube 16. The electric compressor 11 of the present embodiment discharges a medium in which the cooling medium and a lubricating oil are mixed through the discharge tube 16. The compressing portion 20 is not limited to the above-described scroll-type one, and may be, for example, a reciprocating-type, a rotary-type, or a screw-type one.

The electric motor 30 includes a cylindrical stator 40 fixed to the sealed container 13, and a cylindrical rotor 31 disposed on the inner circumferential side of the stator 40. The rotor 31 surrounds the axis C, and the stator 40 surrounds the rotor 31.

The rotor 31 includes a cylindrical rotor core 32 formed by stacking a plurality of thin sheet-like electromagnetic steel sheets in the axis C direction, and a plurality of permanent magnets 33 embedded in the rotor core 32. The rotation shaft 21 is inserted in the inner circumferential side of the rotor core 32, and the rotation shaft 21 is fixed to the rotor core 32 by press-fitting, shrink fitting, or the like. The plurality of permanent magnets 33 are disposed rotationally symmetrically around the axis C. The permanent magnets 33 may be embedded so as to be exposed at the outer circumferential surface of the rotor core 32, or embedded so as not to be exposed.

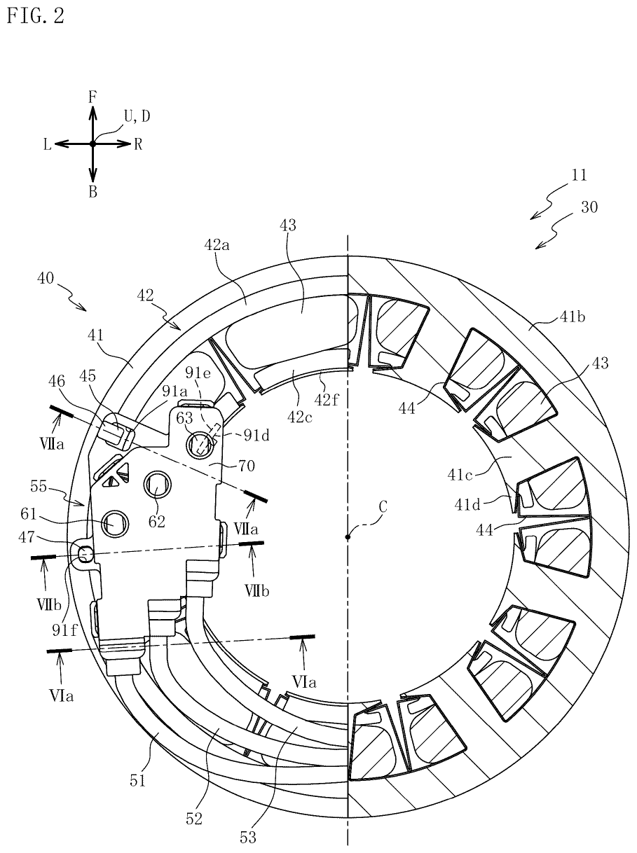

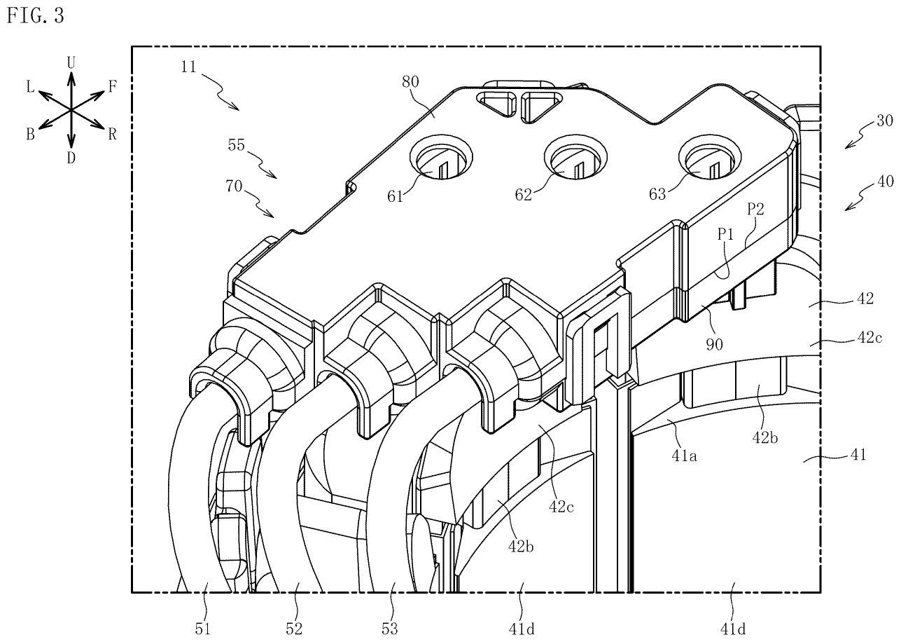

FIG. 2 is a half sectional view of the electric compressor 11 at a line II-II in FIG. 1B. Specifically, in FIG. 2, the right half portion is a cross-sectional view of the electric compressor 11, and the left half portion is a top view thereof. In FIG. 2, the accumulator 12, the sealed container 13, the compressing portion 20, the rotor 31, a control circuit 56, and the like are not shown (they are also omitted in FIG. 3).

As shown in FIG. 1B and FIG. 2, the stator 40 mainly includes a cylindrical stator core 41 fixed to the inner circumferential surface of the sealed container 13, a cylindrical bobbin 42 disposed at each of axial end surfaces 41a on both sides of the stator core 41, and a coil 43 wound around the bobbin 42 and the stator core 41.

The stator core 41 is formed by stacking a plurality of thin sheet-like electromagnetic steel sheets in the axis C direction. The stator core 41 may be formed of an annular electromagnetic steel sheet continuous in the circumferential direction into a cylindrical shape, or formed into a cylindrical shape by connecting a plurality of electromagnetic steel sheets divided in the circumferential direction or the radial direction. The stator core 41 includes a cylindrical yoke portion 41b forming an outer circumferential portion of the stator core 41, and a plurality of tooth portions 41c protruding from the inner circumferential surface of the yoke portion 41b toward the axis C. Inner circumferential end portions 41d on the rotor 31 side in the tooth portion 41c protrude on both sides in the circumferential direction.

The plurality of tooth portions 41c have the same shape, and are aligned at regular intervals in the circumferential direction. A plurality of slots are formed between the tooth portions 41c adjacent in the circumferential direction. In the present embodiment, the number of the tooth portions 41c and the number of the slots are each nine, but may be changed as appropriate.

The concentrated-winding-type coil 43 is inserted in the slot. The coil 43 is not limited to a concentrated-winding-type coil, and may be a distributed winding type coil. In order to prevent the coil 43 from being in direct contact with the inner circumferential surface of the yoke portion 41b, both surfaces of the tooth portion 41c in the circumferential direction, and the outer circumferential surface of the inner circumferential end portion 41d, and to prevent the coils 43 wound around the tooth portions 41c, respectively, adjacent to each other from being in contact with each other, a plurality of insulating buffer sheets 44 are disposed therebetween.

The bobbin 42 is an insulating member for preventing the coil 43 from coming into direct contact with the axial end surface 41a of the stator core 41. The bobbin 42 may be integrally formed in the circumferential direction or may be formed by connecting a plurality of members divided in the circumferential direction or the radial direction, similarly to the stator core 41. The bobbin 42 includes an outer cylindrical wall portion 42a that has a cylindrical shape and protrudes from the axial end surface 41a in the yoke portion 41b in the axis C direction, a plurality of wall connection portions 42b extending inward in the radial direction from the lower portion of the outer cylindrical wall portion 42a along the tooth portions 41c, and a plurality of inner circumferential wall portions 42c each protruding in the axis C direction from the end portion of the wall connection portion 42b on the inner side in the radial direction.

The plurality of wall connection portions 42b have the same shape, and are aligned at regular intervals in the circumferential direction. The plurality of inner circumferential wall portions 42c also have the same shape, and are aligned at regular intervals in the circumferential direction. The number of the wall connection portions 42b and the number of the inner circumferential wall portions 42c are each equal to the number of the tooth portions 41c. The wall connection portion 42b is disposed at the axial end surface 41a in the tooth portion 41c and the inner circumferential end portion 41d, and has almost the same width as the width of the tooth portion 41c excluding the inner circumferential end portion 41d in the circumferential direction. The inner circumferential wall portion 42c is disposed above the inner circumferential end portion 41d, and the width of the inner circumferential wall portion 42c in the circumferential direction is almost the same as the width of the inner circumferential end portion 41d in the circumferential direction.

An axial end surface 42e of the inner circumferential wall portion 42c on the opposite side to the stator core 41 side is disposed on the stator core 41 side at a lower position than an axial end surface 42d of the outer cylindrical wall portion 42a on the opposite side to the stator core 41 side. A part of the coil 43 is stored in a portion surrounded by the outer cylindrical wall portion 42a, the wall connection portion 42b, and the inner circumferential wall portion 42c.

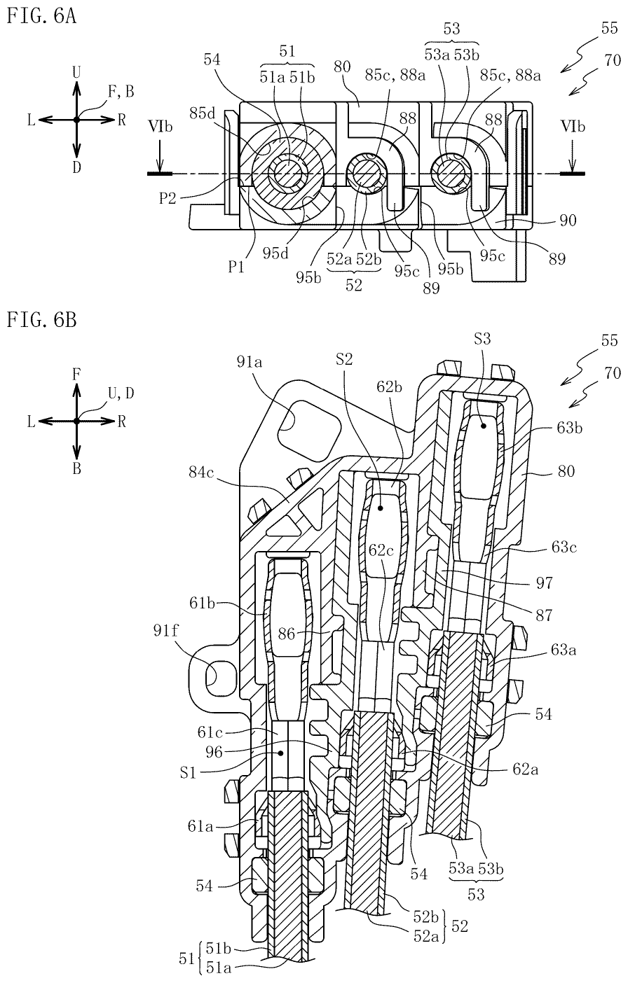

The coil 43 is formed by winding a conductor. The coil 43 is formed of three kinds of coils, that is, a U-phase coil, a V-phase coil, and a W-phase coil. One of motor wires 51, 52, 53 is extracted from a corresponding one of the U-phase, V-phase, and W-phase coils 43. The motor wires 51, 52, and 53 are formed by covering conductors 51a, 52a, 53a with covering portions 51b, 52b, 53b, respectively, formed of an insulating elastic material (see FIG. 6A).

The motor wires 51 to 53 are electrically connected to the control circuit 56 through a connector 55. The connector 55 is disposed at the axial end surfaces 42d, 42e of the bobbin 42 on the upper side on the drawing sheet surface in FIG. 1B, and disposed at the cylindrical bobbin 42 partially in the circumferential direction. The motor wires 51 to 53 extending from the connector 55 toward the electric motor 30 are curved along the circumferential direction around the axis C.

The control circuit 56 is placed in a space 57 obtained by partitioning a space in which the electric motor 30 is disposed, by a partition wall portion 57a, in the sealed container 13. The partition wall portion 57a is disposed at a position opposing the connector 55 in the axis C direction. The space 57 may be disposed outside the sealed container 13, and a part of an outer wall of the sealed container 13 may serve as the partition wall portion 57a.

Three mating terminals 56a, 56b, 56c corresponding to the U-phase, the V-phase, and the W-phase, respectively, protrude from the control circuit 56. The mating terminals 56a to 56c are columnar metal terminals that are electrically connected to the control circuit 56. The mating terminals 56a to 56c penetrate through the partition wall portion 57a, and protrude into a space in which the electric motor 30 is disposed. The ends of the three mating terminals 56a to 56c are each connected to the connector 55, and thus, the mating terminals 56a to 56c are individually connected electrically to the motor wires 51 to 53, respectively.

The control circuit 56 serves as an inverter for controlling an electric current flowing in each of the U-phase, V-phase, and W-phase coils 43 through the mating terminals 56a to 56c, the connector 55, and the motor wires 51 to 53. The control circuit 56 operates to generate a magnetic field for rotating the rotor 31 by the electric current, and performs drive control of the electric motor 30.

Next, the connector 55 will be described in more detail with reference to FIG. 3 to FIG. 7B. In the following description for the connector 55, unless otherwise specified, the control circuit 56 side (upper side on the drawing sheet surface in FIG. 1B) is defined as the upper side of the connector 55, and the axial end surface 42d, 42e side (lower side on the drawing sheet surface in FIG. 1B) is defined as the lower side of the connector 55. Similarly, the inner side (right side on the drawing sheet surface in FIG. 2) in the radial direction of the axis C is defined as the right side of the connector 55, and the outer side (left side on the drawing sheet surface in FIG. 2) in the radial direction of the axis C is defined as the left side of the connector 55. Furthermore, the upper side on the drawing sheet surface in FIG. 2 in the direction perpendicular to the up-down direction and the left-right direction is defined as the front side of the connector 55, and the lower side on the drawing sheet surface in FIG. 2 is defined as the rear side of the connector 55. The motor wires 51 to 53 extend from the rear side of the connector 55. In each of the drawings, an arrow U direction, an arrow D direction, an arrow F direction, an arrow B direction, an arrow L direction, and an arrow R direction represent the upper direction, the lower direction, the front direction, the rear direction, the left direction, and the right direction, respectively, of the connector 55.

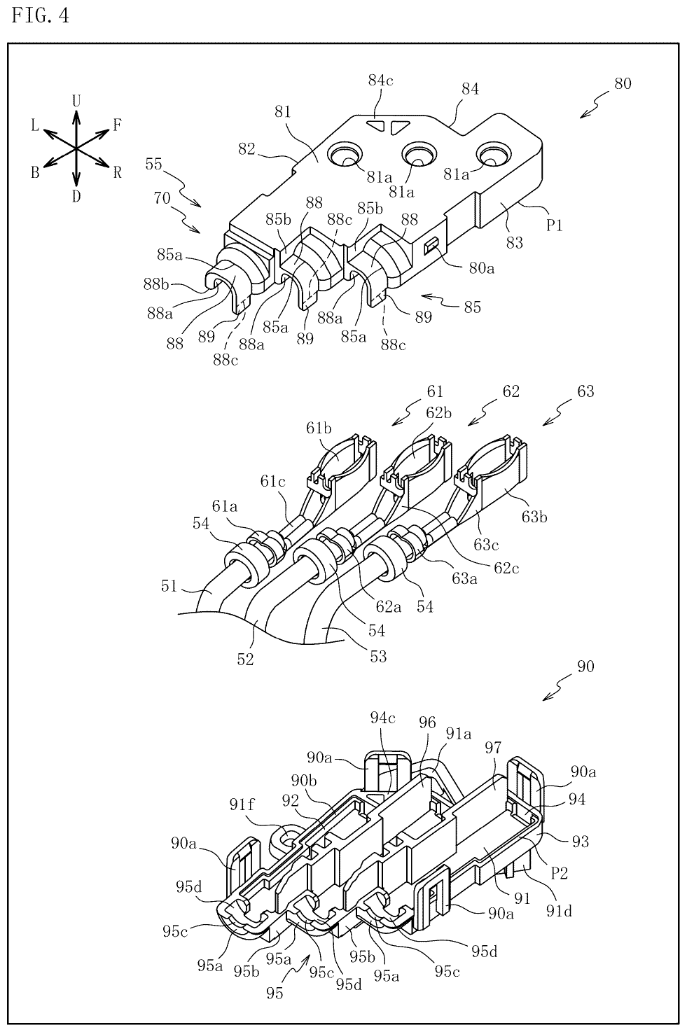

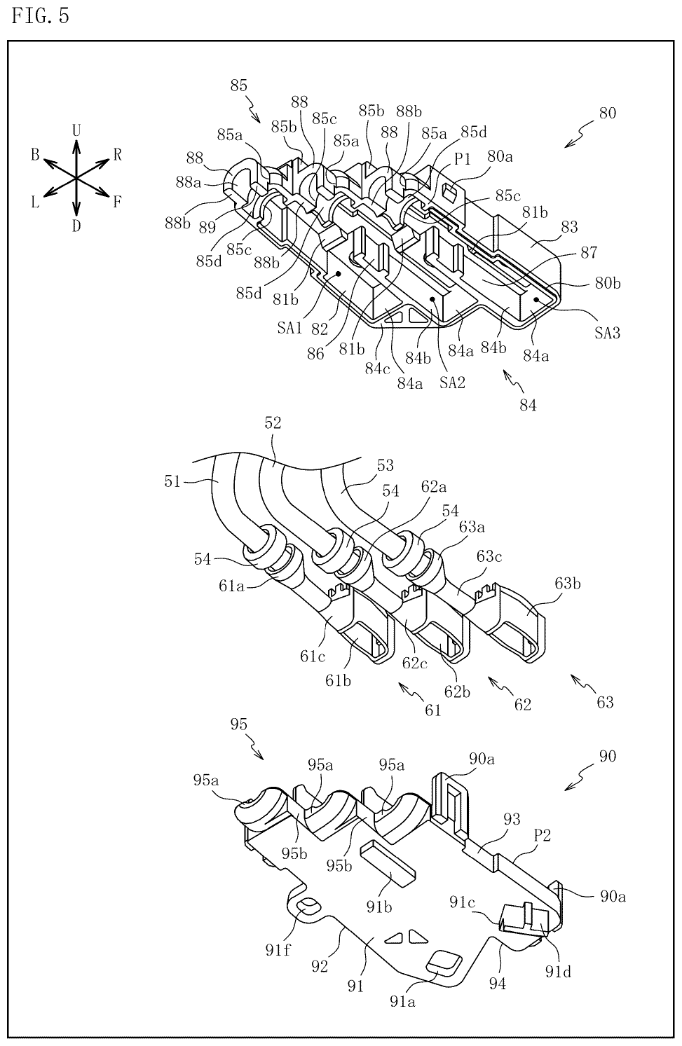

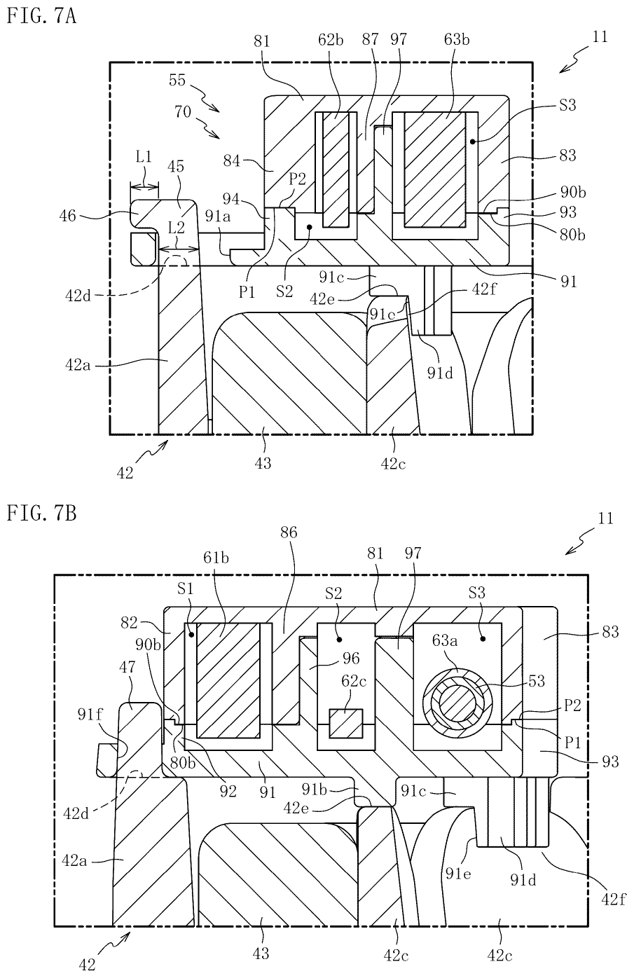

FIG. 3 is a perspective view of an upper side portion of the electric compressor 11 in which a portion near the connector 55 is enlarged. FIG. 4 is an exploded perspective view of the connector 55 as viewed from the upper side (the control circuit 56 side). FIG. 5 is an exploded perspective view of the connector 55 as viewed from the lower side (the bobbin 42 side). FIG. 6A is a cross-sectional view of the connector 55 at a line VIa-VIa in FIG. 2. FIG. 6B is a cross-sectional view of the connector 55 at a line VIb-VIb in FIG. 6A. FIG. 7A is a cross-sectional view of the connector 55 at a line VIIa-VIIa in FIG. 2. FIG. 7B is a cross-sectional view of the connector 55 at a line VIIb-VIIb in FIG. 2. In FIG. 3, almost all of ridge lines of the components of the electric compressor 11 are shown. However, a part of the ridge lines is omitted in the other drawings. In FIG. 7A and FIG. 7B, connection terminals 61 to 63 are schematically shown.

As shown in FIG. 3 and FIG. 4, the connector 55 includes three connection terminals 61, 62, 63, and an insulating cluster block 70 in which the connection terminals 61 to 63 are stored. The connection terminal 61 is a metal terminal disposed at the end of the motor wire 51, and electrically connects the motor wire 51 and the mating terminal 56a to each other. The connection terminal 62 is a metal terminal disposed at the end of the motor wire 52, and electrically connects the motor wire 52 and the mating terminal 56b to each other. The connection terminal 63 is a metal terminal disposed at the end of the motor wire 53, and electrically connects the motor wire 53 and the mating terminal 56c to each other.

The connection terminals 61 to 63 extend in the front-rear direction (circumferential direction around the axis C), and are sequentially aligned rightward (toward the inner side in the radial direction of the axis C) in the order of the connection terminals 61, 62, 63. The connection terminals 61, 62, 63 include cylindrical connection portions 61a, 62a, 63a that cover the motor wires 51, 52, 53, respectively, end portions 61b, 62b, 63b connected to the mating terminals 56a, 56b, 56c, respectively, and linking portions 61c, 62c, 63c linking between the connection portions 61a, 62a, 63a and the end portions 61b, 62b, 63b, respectively.

By reducing the diameters of the connection portions 61a to 63a, the connection portions 61a to 63a are caulked and fixed to the outer circumferential surfaces of the covering portions 51b to 53b of the motor wires 51 to 53. The end portions 61b to 63b are each formed in a rectangular-parallelepiped box-like shape elongated in the front-rear direction. The end portions 61b to 63b have opened upper surfaces for receiving the mating terminals 56a to 56c thereinside.

The linking portions 61c to 63c are portions to which the conductors 51a to 53a exposed from the covering portions 51b to 53b are electrically connected. The linking portions 61c to 63c link the lower portions of the connection portions 61a to 63a and the lower portions of the end portions 61b to 63b to each other in the front-rear direction. Therefore, the linking portions 61c to 63c are formed so as to be lower on the lower side than the upper ends of the connection portions 61a to 63a and the upper ends of the end portions 61b to 63b. The connection portions 61a to 63a are formed so as to be lower on the lower side than the upper ends of the end portions 61b to 63b. The linking portions 61c to 63c are recessed stepwise with respect to the end portions 61b to 63b, and a portion that is gradually inclined upward toward each of the end portions 61b to 63b is a part of each of the linking portions 61c to 63c.

An annular sealing member 54 is disposed at each of the motor wires 51 to 53 near the connection terminals 61 to 63. The sealing member 54 is an annular portion formed of an elastic material, and covers the covering portions 51b to 53b of the motor wires 51 to 53 over the entire circumferences. The inner circumferential surfaces of the sealing members 54 and the outer circumferential surfaces of the covering portions 51b to 53b are adhered to each other over the entire circumferences.

The cluster block 70 is a box-like member disposed on the axial end surfaces 42d, 42e of the bobbin 42, and is divided in the up-down direction (axis C direction) by a division surface. An upper side of the cluster block 70 above the division surface is a first member 80, and the lower side thereof below the division surface is a second member 90. The division surface on the first member 80 side is a division surface P1, and the division surface on the second member 90 side is a division surface P2.

As shown in FIG. 4 and FIG. 5, the first member 80 includes a first plate portion 81 forming the upper surface of the cluster block 70, first outer walls 82, 83, 84, 85 protruding from the outer peripheral portion of the first plate portion 81 toward the second member 90, and first inner walls 86, 87 protruding from the first plate portion 81 toward the second member 90 inside the first outer walls 82 to 85.

The first plate portion 81 is an almost flat-plate-like portion that covers the upper side of the connection terminals 61 to 63. In the first plate portion 81, three round insertion holes 81a in total are individually formed to penetrate therethrough at such positions that the three end portions 61b to 63b, respectively, are covered. The mating terminals 56a to 56c are inserted into the insertion holes 81a, respectively, so that the mating terminals 56a to 56c are electrically connected to the end portions 61b to 63b, respectively.

The first outer wall 82 protrudes from the left edge portion in the outer peripheral portion of the first plate portion 81. The first outer wall 83 protrudes from the right edge portion in the outer peripheral portion of the first plate portion 81, and opposes the first outer wall 82 in the left-right direction. The connection terminals 61 to 63 are aligned in the left-right direction between the first outer walls 82 and 83 opposing each other.

The first outer wall 84 protrudes from the front edge portion in the outer peripheral portion of the first plate portion 81, and connects the front edge portions of the first outer walls 82, 83 to each other. The first outer wall 84 is formed stepwise by three front end walls 84a having inner surfaces with which the respective ends (front ends) of the end portions 61b to 63b of the connection terminals 61 to 63 come into contact, and two front side walls 84b that connect the front end walls 84a in the front-rear direction.

The three front end walls 84a are disposed such that the front end wall 84a closer to the right side is displaced so as to be closer to the front side. An inclined portion 84c is connected to the front end wall 84a and the front side wall 84b closest to the left side, and diagonally fills the corner portion of the front end wall 84a and the front side wall 84b. A claw portion 80a protrudes from each of the outer surface of the inclined portion 84c, the outer surface of the front end wall 84a closest to the right side, and the outer surfaces on the rear sides of the first outer walls 82, 83.

Three hooking protrusions 81b for storing the end portions 61b to 63b protrude from the lower surface of the first plate portion 81 between the three front end walls 84a. A distance in the front-rear direction between the hooking protrusion 81b and the front end wall 84a is almost equal to the length of the end portion 61b, 62b, 63b in the front-rear direction. Thus, the end portions 61b to 63b (connection terminals 61 to 63) can be positioned in the front-rear direction between the hooking protrusions 81b and the front end walls 84a.

The first outer wall 85 protrudes from the rear edge portion in the outer peripheral portion of the first plate portion 81, connects the rear edge portions of the first outer walls 82, 83 to each other, and opposes the first outer wall 84 in the front-rear direction. The outer surface of the first outer wall 85 is formed stepwise by three end surfaces 85a facing rearward, and two side wall surfaces 85b that connect the end surfaces 85a in the front-rear direction, similarly to the first outer wall 84. The three end surfaces 85a are disposed such that the end surface 85a closer to the right side is displaced so as to be closer to the front side. The three end surfaces 85a are continuous, on the same plane, with three end surfaces 95a provided in the second member 90 in a state where the first member 80 and the second member 90 are combined.

The first outer wall 85 has three connecting grooves 85c recessed upward from the division surface P1 (lower end of the first outer wall 85) in a U-like shape such that the connecting grooves 85c are opened at the end surfaces 85a, respectively. The upper sides of the three motor wires 51 to 53 are individually stored in the connecting grooves 85c, respectively, and the connecting grooves 85c are opened also at the inner surface of the first outer wall 85. Sealing grooves 85d are formed in intermediate portions of the connecting grooves 85c by more deeply recessing the connecting grooves 85c, respectively, in a U-like shape. The upper sides of the three sealing members 54 are individually stored in the sealing grooves 85d, respectively, and movement of the stored sealing members 54 in the front-rear and left-right directions is regulated. The outer circumferential surface of the sealing member 54 and the sealing groove 85d are adhered to each other and sealed.

The first member 80 includes three extension portions 88 protruding rearward from the end surfaces 85a, respectively, and three regulation portions 89 protruding downward from the extension portions 88. The extension portion 88 includes an extension groove 88a obtained by extending the connecting groove 85c rearward, and a pair of extension surfaces 88b, 88c that are disposed on both the left and right sides of the extension groove 88a and obtained by extending the division surface P1. Both the left and the right sides of the extension groove 88a refer to both sides, in the radial direction, of a later-described connection hole that is formed by the connecting groove 85c continuous with the extension groove 88a.

The extension groove 88a is formed over the entire length of the extension portion 88 in the front-rear direction. The extension surface 88b is a portion to the left of the extension groove 88a. The extension surface 88c is a portion to the right of the extension groove 88a. The regulation portion 89 protrudes linearly downward from the entire surface of the extension surface 88c on the right side, and protrudes downward of the division surface P1. The extension surface 88c is a boundary between the regulation portion 89 and the extension portion 88, and is hidden by the regulation portion 89, and the extension surface 88c is thus indicated by a dashed line in FIG. 4. The regulation portion 89 is not disposed at the extension surface 88b on the left side, and the entire surface of the extension surface 88b is exposed.

A space surrounded by the first plate portion 81 and the first outer walls 82 to 85 is a first storage space in which the upper sides of the connection terminals 61 to 63 are stored. The first inner walls 86, 87 partition the first storage space into three first individual spaces SA1, SA2, SA3 in which the three connection terminals 61 to 63 are individually stored. The connection terminal 61 is stored in the first individual space SA1, the connection terminal 62 is stored in the first individual space SA2, and the connection terminal 63 is stored in the first individual space SA3. The three first individual spaces SA1 to SA3 individually connect to the three connecting grooves 85c, respectively.

The first inner wall 86 is disposed between the first individual spaces SA1 and SA2, and is formed so as to extend rearward the front side wall 84b on the left side. The first inner wall 87 is disposed between the first individual spaces SA2 and SA3, and is formed so as to extend rearward the front side wall 84b on the right side. The first inner walls 86, 87 are formed so as to be spaced from the first outer wall 85, and the first individual spaces SA1 to SA3 are connected to each other in a portion rearward of the first inner walls 86, 87. The heights of the first inner walls 86, 87 (dimension in the up-down direction) are almost equal to the heights of the first outer walls 82 to 85, and the lower ends of the first inner walls 86, 87 are almost coplanar with the division surface P1.

The second member 90 includes a second plate portion 91 forming the lower surface (bottom plate) of the cluster block 70, second outer walls 92, 93, 94, 95 protruding from the outer peripheral portion of the second plate portion 91 toward the first member 80, and second inner walls 96, 97 protruding from the second plate portion 91 toward the first member 80 inside the second outer walls 92 to 95. Most of the second member 90 is symmetrical with the first member 80 in the up-down direction although the heights in the up-down direction are different.

The second plate portion 91 is an almost flat-plate-like portion that covers the lower sides of the connection terminals 61 to 63, and opposes the first plate portion 81 in the up-down direction with the connection terminals 61 to 63 being disposed therebetween. The second outer wall 92 protrudes from the left edge portion in the outer peripheral portion of the second plate portion 91. The second outer wall 93 protrudes from the right edge portion in the outer peripheral portion of the second plate portion 91, and opposes the second outer wall 92 in the left-right direction. The connection terminals 61 to 63 are aligned in the left-right direction between the second outer walls 92 and 93 opposing each other.

The second outer wall 94 protrudes from the front edge portion in the outer peripheral portion of the second plate portion 91, and connects the front edge portions of the second outer walls 92, 93 to each other. The second outer wall 94 is formed stepwise, similarly to the first outer wall 84. Furthermore, an inclined portion 94c symmetrical with the inclined portion 84c of the first member 80 in the up-down direction is disposed also at the second outer wall 94. A hooking portion 90a to be caught by the claw portion 80a is disposed on each of the outer surface of the inclined portion 94c, the outer surface on the right side of the second outer wall 94, and the outer surfaces on the rear sides of the second outer walls 92, 93, similarly to the claw portion 80a of the first member 80.

The second outer wall 95 protrudes from the rear edge portion in the outer peripheral portion of the second plate portion 91, connects the rear edge portions of the second outer walls 92, 93 to each other, and opposes the second outer wall 94 in the front-rear direction. The outer surface of the second outer wall 95 is formed stepwise by the three end surfaces 95a facing rearward, and two side wall surfaces 95b that connect the end surfaces 95a in the front-rear direction, similarly to the second outer wall 94. The three end surfaces 95a are disposed such that the end surface 95a closer to the right side is displaced so as to be closer to the front side.

Three connecting grooves 95c recessed downward from the division surface P2 (upper end of the second outer wall 95) in an arc-like shape are formed in the second outer wall 95 such that the connecting grooves 95c are opened at the end surfaces 95a, respectively. The lower sides of the three motor wires 51 to 53 are individually stored in the connecting grooves 95c, respectively, and the connecting grooves 95c are opened also at the inner surface of the second outer wall 95. Sealing grooves 95d formed by more deeply recessing the connecting grooves 95c in an arc-like shape are disposed in intermediate portions of the connecting grooves 95c, respectively. The lower sides of the three sealing members 54 are individually stored in the sealing grooves 95d, respectively, and movement of the stored sealing members 54 in the front-rear and the left-right directions is regulated. The outer circumferential surface of the sealing member 54 and the sealing groove 95d are adhered to each other and sealed.

A space surrounded by the second plate portion 91 and the second outer walls 92 to 95 is a second storage space in which the lower sides of the connection terminals 61 to 63 are stored. The second inner walls 96, 97 partition the second storage space into three second individual spaces SB1, SB2, SB3 in which the three connection terminals 61 to 63 are individually stored. The connection terminal 61 is stored in the second individual space SB1, the connection terminal 62 is stored in the second individual space SB2, and the connection terminal 63 is stored in the second individual space SB3. The three second individual spaces SB1 to SB3 individually connect to the three connecting grooves 95c, respectively.

The second inner wall 96 is disposed between the second individual spaces SB1 and SB2. The second inner wall 97 is disposed between the second individual spaces SB2 and SB3. The second inner walls 96, 97 are continuous over the entire lengths between the second outer walls 94, 95, and are connected to the second outer walls 94, 95. The second inner walls 96, 97 are formed so as to be higher than the second outer walls 92 to 95 in the upper direction.

In order to assemble the cluster block 70 (connector 55) described above, the connection terminals 61 to 63, the motor wires 51 to 53, and the sealing members 54 are firstly stored in the portions (the first individual spaces SA1 to SA3, the second individual spaces SB1 to SB3, or the like) in the first member 80 or the second member 90. Subsequently, the division surface P1 as the lower ends of the first outer walls 82 to 85 and the division surface P2 as the upper ends of the second outer walls 92 to 95 are aligned, and the four hooking portions 90a are caught by the four claw portions 80a, respectively. Thus, the first member 80 and the second member 90 are combined with each other, to assemble the cluster block 70.

Such a state in which the first member 80 and the second member 90 are combined is referred to as combined state of the cluster block 70. In the combined state, the four sets of the claw portions 80a and the hooking portions 90a are distant from each other in the front-rear and the left-right directions and face in different directions, so that combination between the first member 80 and the second member 90 can be firmly maintained. The number and positions of the claw portions 80a and the number and positions of the hooking portions 90a may be changed as appropriate, and the hooking portions 90a may be disposed at the first member 80, and the claw portions 80a may be disposed at the second member 90.

A lock-engagement stepped portion 80b having the inner side protruding stepwise as compared with the outer side is continuously formed almost over the entire periphery in the division surface P1 of the first outer walls 82 to 84. Meanwhile, a lock-engagement stepped portion 90b having the inner side recessed stepwise as compared with the outer side is continuously formed almost over the entire periphery in the division surface P2 of the second outer walls 92 to 94. In the combined state, the lock-engagement stepped portions 80b and 90b mesh with each other, and deviation between the first member 80 and the second member 90 can thus be inhibited.

In the combined state, the first outer walls 82 to 84 and the second outer walls 92 to 94 become continuous, to form an outer peripheral wall that connects the outer peripheral portion of the first plate portion 81 and the outer peripheral portion of the second plate portion 91 to each other. The first storage space and the second storage space described above overlap in the up-down direction to form a storage space in a portion surrounded by the outer peripheral wall between the first plate portion 81 and the second plate portion 91.

In the combined state, the first individual space SA1 of the first member 80 and the second individual space SB1 of the second member 90 overlap in the up-down direction to form one individual space S1 (see FIG. 6B and the like). Similarly, one individual space S2 is formed by the first individual space SA2 and the second individual space SB2, and one individual space S3 is formed by the first individual space SA3 and the second individual space SB3. Furthermore, the three connecting grooves 85c, 95c (including the sealing grooves 85d, 95d) overlap in the up-down direction, to form three connection holes opened at the end surfaces 85a, 95a, respectively. The cluster block 70 is divided into the first member 80 and the second member 90 by the division surfaces P1, P2 passing through the three connection holes and the three individual spaces S1, S2, S3.

As shown in FIG. 6A, the division surfaces P1, P2 are displaced downward from the axes of the motor wires 51 to 53 stored in the connection holes (the connecting grooves 85c, 95c and the sealing grooves 85d, 95d). Thus, the connecting grooves 85c are relatively deep and the connecting grooves 95c are relatively shallow in the up-down direction, the sealing grooves 85d are relatively deep and the sealing grooves 95d are relatively shallow, and the first outer walls 82 to 85 are relatively high and the second outer walls 92 to 95 are relatively low in the up-down direction.

In the present embodiment, in order to inhibit a fluid such as a cooling medium from entering the inside of the cluster block 70 from a gap between the motor wires 51 to 53 and the connection holes, the outer circumferential surfaces of the sealing members 54 are adhered to the sealing grooves 85d, 95d over the entire circumference to close the gap. The present invention is not limited thereto. The sealing members 54 and the sealing grooves 85d, 95d may be omitted, and the covering portions 51b to 53b of the motor wires 51 to 53 may be adhered to the connecting grooves 85c, 95c over the entire circumference, to close the gap.

In any case, when the cluster block 70 is assembled, the covering portions 51b to 53b or the sealing members 54 are likely to be caught by the division surfaces P1, P2. Particularly, in a case where the connecting grooves 85c, 95c and the sealing grooves 85d, 95d have a semi-circular shape having the same size, the covering portions 51b to 53b and the sealing members 54 are pressed against the grooves and may be deformed in the left-right direction so as to protrude from the grooves, and are likely to be caught by the division surfaces P1, P2.

Meanwhile, since the connecting grooves 85c and the sealing grooves 85d are deeply formed, in a case where the covering portions 51b to 53b and the sealing members 54 are firstly stored in the connecting grooves 85c and the sealing grooves 85d, deformation thereof in the left-right direction can be regulated by the inner walls of the connecting grooves 85c and the sealing grooves 85d, during assembling of the cluster block 70. As a result, the covering portions 51b to 53b and the sealing members 54 can be made unlikely to be caught by the division surfaces P1, P2 during the assembling.

In assembling of the cluster block 70, also in a case where the covering portions 51b to 53b and the like are firstly stored in the shallow connecting grooves 95c and the like, the covering portions 51b to 53b and the like can be made unlikely to be caught by the division surfaces P1, P2. This is because, before the covering portions 51b to 53b and the like are held between the connecting grooves 85c and the like and the connecting grooves 95c and the like and the covering portions 51b to 53b and the like are deformed in the left-right direction, since the inner walls of the connecting grooves 85c and the like are positioned on the left and the right sides of the covering portions 51b to 53b and the like, the deformation can be regulated by the inner walls.

As shown in FIG. 4 and FIG. 6A, when the cluster block 70 is assembled, if the motor wires 51 to 53 stored in the first member 80 are moved on a side outward of the end surfaces 85a, the covering portions 51b to 53b and the like are likely to be caught by the division surfaces P1, P2. Meanwhile, in the present embodiment, the motor wires 51 to 53 are disposed along the extension grooves 88a of the extension portions 88 protruding from the end surfaces 85a, and such a movement can thus be regulated. Thus, the covering portions 51b to 53b and the like can be made more unlikely to be caught by the division surfaces P1, P2 near the end surfaces 85a, 95a.

If the extension portions 88 are disposed in the second member 90 as well as the first member 80, the covering portions 51b to 53b and the like are likely to be caught by the extension surfaces 88b, 88c that are the division surfaces between the extension portions 88. However, in the present embodiment, the extension portions 88 are disposed merely in the first member 80, and such catching can thus be prevented.

Furthermore, since the extension portions 88 are disposed in the first member 80, the extension grooves 88a can be deeply formed similarly to the connecting grooves 85c. As a result, when the cluster block 70 is assembled, movement of the motor wires 51 to 53 stored in the extension grooves 88a can be more easily regulated, and the covering portions 51b to 53b and the like can be made more unlikely to be caught by the division surfaces P1, P2 near the end surfaces 85a, 95a.

The regulation portions 89 protrude, along the end surfaces 95a of the second member 90 which does not have the extension portions 88, from the extension surfaces 88c on the right side of the extension portions 88. Thus, when the cluster block 70 is assembled, even if the motor wires 51 to 53 float from the connecting grooves 85c, 95c and the extension grooves 88a, movement of the floating portions of the motor wires 51 to 53 can be regulated by the regulation portions 89. Therefore, the covering portions 51b to 53b and the like can be made more unlikely to be caught by the division surfaces P1, P2 near the end surfaces 85a, 95a.

The regulation portions 89 may protrude from the extension surfaces 88b on the left side of the extension portions 88. Also in this case, the covering portions 51b to 53b and the like can be made unlikely to be caught by the division surfaces P1, P2 near the end surfaces 85a, 95a.

However, in the present embodiment, since the plurality of end surfaces 95a of the second member 90 are connected stepwise through the side wall surfaces 95b, the regulation portions 89 are preferably disposed at the extension surfaces 88c that are distant from the side wall surfaces 95b in the left-right direction (radial direction of the connection hole). Thus, when the cluster block 70 is assembled, even if the motor wires 51 to 53 float from the connecting grooves 85c, 95c and the extension grooves 88a, movement of the floating portions of the motor wires 51 to 53 can be regulated by the regulation portions 89 and the side wall surfaces 95b opposing each other. Therefore, the covering portions 51b to 53b and the like can be made more unlikely to be caught by the division surfaces P1, P2 near the end surfaces 85a, 95a.

The motor wires 51 to 53 extending from the cluster block 70 are curved rightward along the circumferential direction of the axis C (see FIG. 2). Therefore, when the cluster block 70 is assembled, the motor wires 51 to 53 floating from the connecting grooves 85c, 95c and the extension grooves 88a are likely to be displaced rightward, and the covering portions 51b to 53b and the like are likely to be caught by the division surfaces P1, P2 on the right side of the connecting grooves 85c, 95c. However, the regulation portions 89 protrude from the extension surfaces 88c on the right side of the extension grooves 88a, and such displacement of the motor wires 51 to 53 in the right direction can thus be regulated by the regulation portions 89. Thus, the covering portions 51b to 53b and the like can be made unlikely to be caught by the division surfaces P1, P2 in an effective manner according to the direction in which the motor wires 51 to 53 are curved.

Although the regulation portions 89 may protrude from both of the pair of the extension surfaces 88b, 88c, the regulation portions 89 preferably protrude merely from the extension surfaces 88c on the right side. This is because the covering portions 51b to 53b and the like are unlikely to be caught by the division surfaces P1, P2 on the left side of the connecting grooves 85c, 95c owing to the direction in which the motor wires 51 to 53 are curved and the existence of the side wall surfaces 95b. In a case where the regulation portions 89 do not protrude from the extension surfaces 88b on the left side, the weight of the cluster block 70 can be reduced, and an amount of materials to be used can be reduced.

In assembling of the cluster block 70, in a case where the connection terminals 61 to 63 are firstly stored in the first individual spaces SA1 to SA3 of the first member 80 surrounded by the high first outer walls 82 to 85, the connection terminals 61 to 63 are made unlikely to be inclined. Therefore, the connection terminals 61 to 63 can be easily held stably by the first member 80 during the assembling. Furthermore, since the heights of the first inner walls 86, 87 and the heights of the first outer walls 82 to 85 are almost equal to each other among the first individual spaces SA1 to SA3, the connection terminals 61 to 63 are likely to be more stably held by the first member 80.

Although the first individual spaces SA1 to SA3 are surrounded by the high first outer walls 82 to 85 and the high first inner walls 86, 87, the first inner walls 86, 87 are partially omitted. Therefore, an operation of storing the connection terminals 61 to 63 in the first individual spaces SA1 to SA3 and an operation of taking out the connection terminals 61 to 63 from the first individual spaces SA1 to SA3 can be facilitated.

As shown in FIG. 7A and FIG. 7B, in the up-down direction in which the first plate portion 81 and the second plate portion 91 oppose each other, the ends (division surface P1) of the first outer walls 82 to 85 are disposed closer to the second plate portion 91 than to the center, in the up-down direction, of the end portions 61b to 63b of the connection terminals 61 to 63 in contact with the first plate portion 81. That is, the first outer walls 82 to 85 are formed so as to be relatively high with respect to the end portions 61b to 63b. Thus, when the cluster block 70 is assembled, the connection terminals 61 to 63 are likely to be more stably held by the first member 80 owing to the high first outer walls 82 to 85.

In the combined state shown in FIG. 6B and FIG. 7B, a part of the inner wall portions for separating the three individual spaces S1, S2, S3 in which the three connection terminals 61 to 63, respectively, are individually stored is formed by overlapping of the first inner walls 86, 87 and the second inner walls 96, 97. In the overlapping portion, an insulating distance between the adjacent connection terminals 61 to 63 is not linear, and a detour is made among the first inner walls 86, 87 and the second inner walls 96, 97, and thus, the insulating distance can be ensured. By ensuring the insulating distance, the individual spaces S1, S2, S3 can be easily made close to each other, and the size of the cluster block 70 can be easily reduced.

In the connection terminals 61 to 63, the connection portions 61a to 63a are lower on the second plate portion 91 side as compared with the end portions 61b to 63b, and the linking portions 61c to 63c are even lower on the second plate portion 91 side as compared with the connection portions 61a to 63a. The inner wall portions positioned adjacent to the relatively high end portions 61b to 63b are formed by overlapping of the first inner walls 86, 87 and the second inner walls 96, 97, to ensure the insulating distance as described above.

Meanwhile, the inner wall portions between the linking portions 61c to 63c are formed merely by the second inner walls 96, 97. The second inner walls 96, 97 protrude from the second plate portion 91 to positions higher than the positions of the linking portions 61c to 63c. Therefore, even if the first inner walls 86, 87 and the second inner walls 96, 97 do not overlap, an insulating distance between the linking portions 61c to 63c can be ensured by detouring around the second inner walls 96, 97. Furthermore, in a case where overlapping of the first inner walls 86, 87 and the second inner walls 96, 97 is partially omitted, the size and the weight of the cluster block 70 can be easily reduced, and an amount of a material to be used for the cluster block 70 can be easily reduced.

The adjacent individual spaces S1, S2 are displaced such that the linking portion 61c in the individual space S1 and the connection portion 62a in the individual space S2 are adjacent to each other. Similarly, the adjacent individual spaces S2, S3 are displaced such that the linking portion 62c in the individual space S2 and the connection portion 63a in the individual space S3 are adjacent to each other. The inner wall portions between the connection portions 62a, 63a and the linking portions 61c, 62c are also formed merely by the second inner walls 96, 97.

Also in such a case, since the second inner walls 96, 97 protrude from the second plate portion 91 to positions higher than the positions of the connection portions 62a, 63a and the linking portions 61c, 62c, an insulating distance between the connection portions 62a, 63a and the linking portions 61c, 62c can be ensured, similarly to the insulating distance between the linking portions 61c to 63c. Furthermore, a portion at which overlapping of the first inner walls 86, 87 and the second inner walls 96, 97 can be omitted can be increased, and, for example, the size of the cluster block 70 is thus likely to be further reduced.

Next, a cluster block fixing structure for mounting the cluster block 70 to the bobbin 42 of the electric motor 30 will be described. As shown in FIG. 7A and FIG. 7B, the bottom surface (lower surface) of the second plate portion 91 as the bottom plate of the cluster block 70 is brought into contact with the axial end surfaces 42d, 42e of the bobbin 42. The axial end surface 42e is positioned at a lower position in the lower direction than the axial end surface 42d, and the bottom surface of the second plate portion 91 is structured so as to absorb the difference in the height. Specifically, the bottom surface of the second plate portion 91 has adjusting protrusions 91b, 91c protruding downward, at a position corresponding to the axial end surface 42e, and the lower ends of the adjusting protrusions 91b, 91c come into contact with the axial end surface 42e.

A first through hole 91a penetrating through the second plate portion 91 in the up-down direction is formed at a portion protruding outward of the second outer wall 94 in the second plate portion 91. A protrusion 45 to be inserted into the first through hole 91a protrudes from the axial end surface 42d of the bobbin 42. Thus, movement of the cluster block 70 relative to the bobbin 42 in directions other than the upper direction is basically regulated.

Furthermore, the end of the protrusion 45 inserted in the first through hole 91a is positioned upward of the second plate portion 91, and a projection 46 projects outward from the end in the radial direction of the axis C. Thus, a part of the second plate portion 91 around the first through hole 91a and the projection 46 oppose each other in the up-down direction. As a result, when the cluster block 70 is moved upward relative to the bobbin 42, the second plate portion 91 is caught by the projection 46, and thus, the upward movement of the cluster block 70 can also be regulated.

A wall portion 91d having a regulation surface 91e which faces toward the first through hole 91a in the protruding direction of the protrusion 45 protrudes so as to extend downward from the bottom surface of the second plate portion 91. In the present embodiment, the first through hole 91a is displaced rearward in the circumferential direction from the front surface position of the regulation surface 91e as viewed in the up-down direction. The wall portion 91d is connected to the adjusting protrusion 91c such that the regulation surface 91e protrudes from the adjusting protrusion 91c. The regulation surface 91e comes into contact with a contact surface 42f that is an inner circumferential wall surface of the inner circumferential wall portion 42c in a state where the protrusion 45 is inserted in the first through hole 91a, and a part of the second plate portion 91 around the first through hole 91a and the projection 46 oppose each other in the up-down direction.

Thus, even if the second plate portion 91 is attempted to be relatively moved in the projecting direction of the projection 46 so as to release opposing of the second plate portion 91 and the projection 46, the relative movement is regulated by the contact between the regulation surface 91e and the contact surface 42f, and releasing of the opposing can be inhibited. As a result, the cluster block 70 can be made unlikely to be detached from the bobbin 42.

Meanwhile, when the cluster block 70 is mounted to the bobbin 42, the projection 46 and the protrusion 45 are firstly inserted into the first through hole 91a in a state where the second plate portion 91 is inclined such that the wall portion 91d side portion of the second plate portion 91 is away from the inner circumferential wall portion 42c of the bobbin 42. The length of the first through hole 91a in the projecting direction of the projection 46 is larger than the total of the projection length L1 of the projection 46 from the protrusion 45 to the end of the projection 46, and the thickness L2 in the dimensions of the protrusion 45 in the projecting direction of the projection 46. Thus, the protrusion 45 and the projection 46 can be easily inserted into the first through hole 91a.

After the insertion into the first through hole 91a, the wall portion 91d side portion of the second plate portion 91 is inclined by using the first through hole 91a as a pivot, and the regulation surface 91e is caused to oppose the contact surface 42f while the second plate portion 91 is brought into contact with the axial end surfaces 42d, 42e of the bobbin 42. Thus, the cluster block 70 can be easily mounted to the bobbin 42. As a result, the cluster block 70 can be easily mounted to the bobbin 42, and simultaneously, detachment of the cluster block 70 from the bobbin 42 after the mounting of the cluster block 70 can be made difficult.

The projection length L1 of the projection 46 is half or more the thickness L2 of the protrusion 45 in the first through hole 91a. Thus, since the projection length L1 is ensured to some degree, opposing of the second plate portion 91 and the projection 46 can be inhibited from being released due to the projection 46 being disengaged from the first through hole 91a by, for example, deformation of the protrusion 45 and the projection 46. Therefore, the cluster block 70 can be made more unlikely to be detached from the bobbin 42.

The second plate portion 91 is continuous around the entire periphery of the first through hole 91a, and the first through hole 91a is not opened over the entire periphery. Therefore, the second plate portion 91 around the first through hole 91a can be made unlikely to be deformed, and opposing of the second plate portion 91 and the projection 46 can be inhibited from being released due to the projection 46 being disengaged from the first through hole 91a according to the deformation. Therefore, the cluster block 70 can be made more unlikely to be detached from the bobbin 42.

Since the motor wires 51 to 53 extending from the cluster block 70 are curved along the circumferential direction around the axis C, a force is applied to the cluster block 70 toward the outer side in the radial direction relative to the bobbin 42 of the electric motor 30 due to an elastic reaction force of the motor wires 51 to 53. The contact surface 42f is an inner circumferential wall surface facing inward in the radial direction in the bobbin 42. Therefore, the regulation surface 91e of the cluster block 70 is pressed against the contact surface 42f due to the elastic reaction force. Thus, contact between the contact surface 42f and the regulation surface 91e can be easily maintained due to the elastic reaction force of the motor wires 51 to 53, and accuracy for positioning the cluster block 70 relative to the bobbin 42 in the radial direction can be enhanced.

As shown in FIG. 2 and FIG. 7B, a portion protruding outward from the second outer wall 92 in the second plate portion 91 has a second through hole 91f penetrating through the second plate portion 91 in the up-down direction. The second through hole 91f is disposed so as to be distant from the first through hole 91a in the direction (the front-rear direction of the cluster block 70) perpendicular to the projecting direction of the projection 46.

An insertion portion 47 that can be inserted into the second through hole 91f protrudes from the axial end surface 42d of the bobbin 42. The insertion portion 47 is implemented as a pin in which the entire periphery of the outer peripheral surface is exposed, and does not have a portion projecting in the radial direction, such as the projection 46. The size of the insertion portion 47 is set such that the insertion portion 47 fits into the second through hole 91f through a slight gap.

After the insertion portion 47 is thus inserted into the second through hole 91f, and the cluster block 70 is mounted to the bobbin 42, even if the cluster block 70 is attempted to be inclined merely in the projecting direction of the projection 46 by using the first through hole 91a as a pivot, the second plate portion 91 around the second through hole 91f and the insertion portion 47 interfere with each other, and the inclination is difficult. Meanwhile, in a case where the cluster block 70 is inclined so as to lift the linear line portion connecting the wall portion 91d and the second through hole 91f to each other by using the first through hole 91a as a pivot, the second plate portion 91 and the insertion portion 47 are unlikely to interfere with each other, and the contact surface 42f and the regulation surface 91e are unlikely to interfere with each other, so that the inclination can be facilitated. By such inclination, the cluster block 70 can be easily detached from the bobbin 42 and the cluster block 70 can be easily mounted to the bobbin 42. Therefore, in a case where an operator knows the method for mounting the cluster block 70, reduction of the mountability can be inhibited, and furthermore, the cluster block 70 can be inhibited from being unintentionally detached since the detachment method is limited.

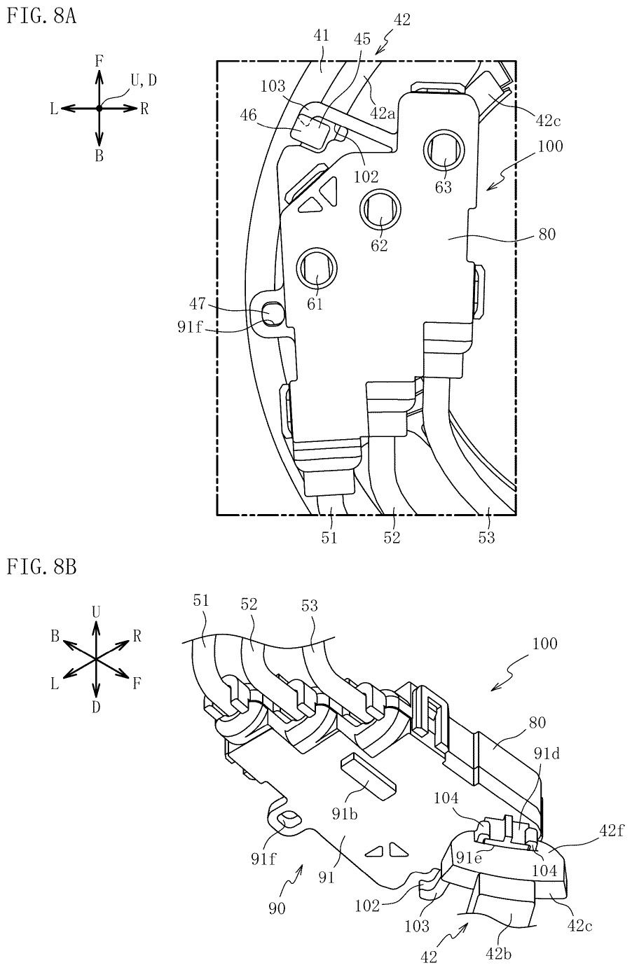

Next, a second embodiment will be described with reference to FIG. 8A and FIG. 8B. In the first embodiment, the first through hole 91a is not opened over the entire periphery. Meanwhile, in the second embodiment, a first through hole 102 is partially opened. The same components as in the first embodiment are denoted by the same reference characters, and the description thereof is omitted. FIG. 8A is a top view of an electric compressor having a cluster block 100 according to the second embodiment. FIG. 8B is a perspective view of a connector having the cluster block 100.

In the second plate portion 91 of the second member 90 of the cluster block 100, the first through hole 102 is formed instead of the first through hole 91a according to the first embodiment. The cluster block 100 and the cluster block 70 of the first embodiment have the same configuration except for the first through hole 102 and a portion around the first through hole 102.

A part of the rear side of the first through hole 102 on the outer side in the radial direction is opened at the edge of the second plate portion 91 on the outer side in the radial direction. Thus, the second plate portion 91 on the front side around the first through hole 102 is formed as a hook portion 103 in which the end of the portion extending outward in the radial direction is curved rearward into a claw-like shape.

When the cluster block 100 is mounted to the bobbin 42, the insertion portion 47 is firstly inserted into the second through hole 91f such that the hook portion 103 is positioned inward of the protrusion 45 in the radial direction, and the lower surface of the second plate portion 91 is brought into contact with the axial end surfaces 42d, 42e of the bobbin 42. Thereafter, the hook portion 103 is rotated around the insertion portion 47 and elastically deformed while the hook portion 103 is pressed against the protrusion 45, and the hook portion 103 is caught by the protrusion 45 below the projection 46. Thus, the cluster block 100 can be easily mounted to the bobbin 42.

The direction in which the hook portion 103 is pressed against the protrusion 45 when the cluster block 100 is mounted is the same as the direction in which a force is applied to the cluster block 100 due to an elastic reaction force of the motor wires 51 to 53 relative to the bobbin 42. Therefore, by using the elastic reaction force, the hook portion 103 can be pressed against the protrusion 45 and elastically deformed, and the hook portion 103 can be easily caught by the protrusion 45.

Also in the second embodiment in which the first through hole 102 is opened by the hook portion 103, the cluster block 100 may be mounted to the bobbin 42 in the same method as in the first embodiment. Specifically, after the protrusion 45 and the projection 46 are inserted into the first through hole 102, the wall portion 91d side portion of the second plate portion 91 may be inclined by using the first through hole 102 as a pivot, and the second plate portion 91 may thus be brought into contact with the axial end surface 42e.

A pair of attachment portions 104 to be caught by the wall portion 91d protrude from the contact surface 42f of the bobbin 42 according to the second embodiment. The bobbin 42 of the first embodiment and the bobbin 42 of the second embodiment have the same configuration except that the attachment portions 104 are disposed in the second embodiment.

The pair of attachment portions 104 protrude inward in the radial direction from the contact surface 42f along both sides, in the circumferential direction, of the wall portion 91d in which the regulation surface 91e is brought into contact with the contact surface 42f, and the ends of the attachment portions 104 are formed so as to be curved toward each other into a claw-like shape. The ends of the attachment portions 104 come into contact with the inner surface of the wall portion 91d in the radial direction. By the pair of attachment portions 104, contact between the contact surface 42f and the regulation surface 91e can be more easily maintained, and accuracy for positioning the cluster block 100 relative to the bobbin 42 in the radial direction can be further enhanced.

When the pair of attachment portions 104 are caught by the wall portion 91d, the wall portion 91d is pressed against the pair of attachment portions 104, and the pair of attachment portions 104 are elastically deformed in the direction in which the attachment portions 104 are away from each other. As in the first embodiment, after the protrusion 45 is inserted into the first through hole 102, the wall portion 91d side portion of the second plate portion 91 may be inclined by using the first through hole 102 as a pivot, and the attachment portions 104 may be caught by the wall portion 91d when the second plate portion 91 is brought into contact with the axial end surface 42e. In this case, the number of steps is slightly increased since the wall portion 91d is pressed against the pair of attachment portions 104.

However, in the present embodiment, as described above, after the second plate portion 91 is brought into contact with the axial end surfaces 42d, 42e, the hook portion 103 is rotated around the insertion portion 47, and the hook portion 103 can be caught by the protrusion 45. Therefore, simultaneously with the rotation, the attachment portions 104 can be caught by the wall portion 91d, and thus, the cluster block 100 can be easily mounted to the bobbin 42 without substantially increasing the number of steps even in a case where the attachment portions 104 are disposed.

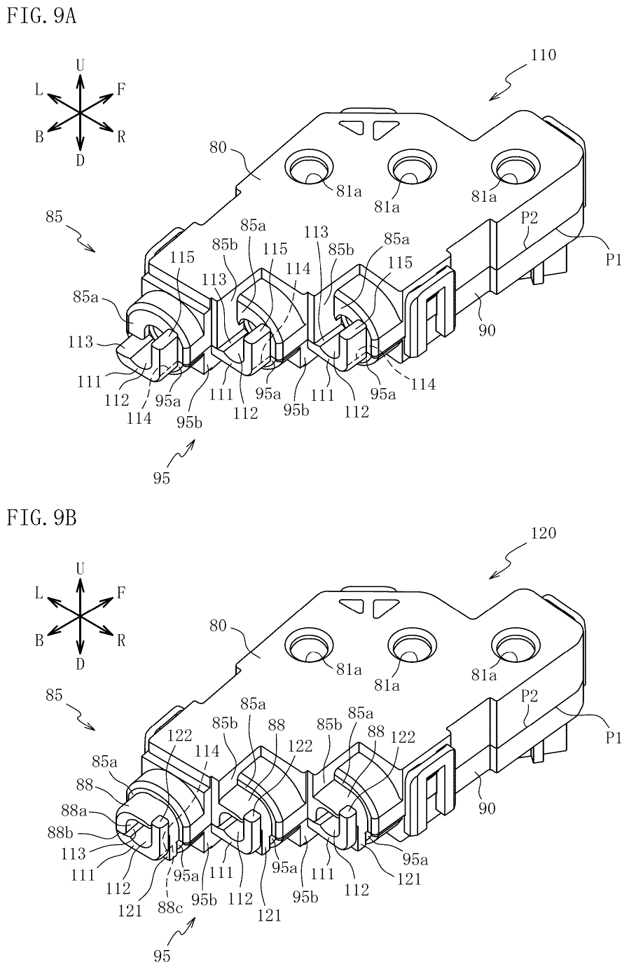

Next, a third embodiment will be described with reference to FIG. 9A. In the first embodiment, the first member 80 has the extension portions 88 and the regulation portions 89. Meanwhile, in the third embodiment, the second member 90 has extension portions 111 and regulation portions 115. The same components as in the first embodiment are denoted by the same reference characters, and the description thereof is omitted. FIG. 9A is a perspective view of a cluster block 110 according to the third embodiment.

The cluster block 110 has the same configuration as the cluster block 70 of the first embodiment except that the first member 80 does not have the extension portions 88 and the regulation portions 89, and the second member 90 has the extension portions 111 and the regulation portions 115, in the cluster block 110.

The extension portions 111 protrude rearward from the three end surfaces 95a, respectively, of the second member 90, and the total number of the extension portions 111 is three. The extension portion 111 includes an extension groove 112 obtained by extending the connecting groove 95c (see FIG. 4) rearward, and a pair of extension surfaces 113, 114 disposed on both the left and right sides (both sides of the connection hole in the radial direction) of the extension groove 112 and obtained by extending the division surface P2. The extension groove 112 is formed over the entire length of the extension portion 111 in the front-rear direction. The extension surface 113 is a portion to the left of the extension groove 112. The extension surface 114 is a portion to the right of the extension groove 112. The extension surface 114 is a boundary between the regulation portion 115 and the extension portion 111, and is hidden by the regulation portion 115, and the extension surface 114 is thus indicated by a dashed line in FIG. 9A.

By the extension portions 111 of the second member 90 having such a configuration, the covering portions 51b to 53b and the like can be made unlikely to be caught by the division surfaces P1, P2 near the end surfaces 85a, 95a, similarly to the extension portions 88 of the first member 80 according to the first embodiment. Since the first member 80 does not have the extension portions 88, the covering portions 51b to 53b and the like can be prevented from being caught between the extension portions 88 and the extension surfaces 113, 114 of the extension portions 111.

The regulation portion 115 linearly protrudes upward from the entire surface of the extension surface 114 on the right side, and protrudes upward of the division surface P2. The regulation portions 115 are formed along the end surfaces 85a of the first member 80. By the regulation portions 115, the covering portions 51b to 53b and the like can be made more unlikely to be caught by the division surfaces P1, P2 near the end surfaces 85a, 95a, similarly to the regulation portions 89 of the first member 80 according to the first embodiment.

Since movement of the motor wires 51 to 53 can be regulated between the regulation portions 115 and the side wall surfaces 85b opposing each other, and the regulation portions 115 are disposed in the direction in which the motor wires 51 to 53 are curved, the covering portions 51b to 53b and the like can be made more unlikely to be caught by the division surfaces P1, P2, similarly to the first embodiment.

The extension surface 113 on the left side does not have the regulation portion 115 and the entire surface of the extension surface 113 is exposed. Similarly to the first embodiment, since the regulation portions 115 are not disposed on the left side on which the covering portions 51b to 53b and the like are unlikely to be caught, the weight of the cluster block 110 and an amount of materials to be used can be reduced.

Next, a fourth embodiment will be described with reference to FIG. 9B. In the first embodiment, the first member 80 has the extension portions 88 and the regulation portions 89, and the second member 90 does not have the extension portions 111 and the regulation portions 115. Meanwhile, in the fourth embodiment, both the first member 80 and the second member 90 have the extension portions 88, 111 and regulation portions, respectively. The same components as in the first and the third embodiments are denoted by the same reference characters, and the description thereof is omitted. FIG. 9B is a perspective view of a cluster block 120 according to the fourth embodiment.

The first member 80 of the cluster block 120 has first regulation portions 121 instead of the regulation portions 89 in the first member 80 of the cluster block 70 according to the first embodiment, and the other configurations of the first members 80 are almost the same. The second member 90 of the cluster block 120 has second regulation portions 122 instead of the regulation portions 115 in the second member 90 of the cluster block 110 according to the third embodiment, and the other configurations of the second members 90 are almost the same.

In the combined state of the cluster block 120 in which the division surfaces P1 and P2 of the first member 80 and the second member 90 are combined, the extension surfaces 88b of the extension portions 88 of the first member 80 and the extension surfaces 113 of the extension portions 111 of the second member 90 mate with each other. However, the extension surfaces 113 protrude toward the extension grooves 88a, 112 as compared with the extension surfaces 88b. Therefore, the covering portions 51b to 53b and the like can be made unlikely to be caught between the extension surfaces 88b and 113.

The first regulation portions 121 linearly protrude downward from the extension surfaces 88c on the right side, and protrude downward of the division surface P1. The first regulation portions 121 are formed along the end surfaces 95a of the second member 90. A part of the extension portion 111 is removed so as to avoid the first regulation portion 121 (such that fitting of the first regulation portion 121 is allowed). The second regulation portions 122 linearly protrude upward from the extension surfaces 114 on the right side, and protrude upward of the division surface P2. The second regulation portions 122 are formed along the first regulation portions 121. A part of the extension portion 88 is removed so as to avoid the second regulation portion 122 (such that fitting of the second regulation portion 122 is allowed).

Thus, as in the first and the third embodiments, when the cluster block 120 is assembled, even if the motor wires 51 to 53 float from the extension grooves 88a, 112, movement of the floating portions of the motor wires 51 to 53 can be regulated by the first regulation portions 121 and the second regulation portions 122. As a result, the covering portions 51b to 53b and the like can be made unlikely to be caught by the extension surfaces 88b, 113 and the division surfaces P1, P2.

Furthermore, in the combined state, the first regulation portions 121 and the second regulation portions 122 protruding perpendicularly from the extension surfaces 88c, 114, respectively, overlap each other along the extension grooves 88a, 112. When the cluster block 120 is assembled such that the first member 80 and the second member 90 are made close relative to each other in the perpendicular direction, the first regulation portions 121 and the second regulation portions 122 slide relative to each other. Thus, the covering portions 51b to 53b and the like can be made unlikely to be caught between the first regulation portions 121 and the second regulation portions 122 that slide, in comparison to between the extension surfaces 88c, 114 gradually approaching each other in the up-down direction and between the division surfaces P1, P2 gradually approaching each other in the up-down direction during the assembling.

Although the present invention has been described above with reference to the embodiments, the present invention is not limited to the above-described embodiments in any way. It can be easily understood that various modifications can be devised without departing from the gist of the present invention.

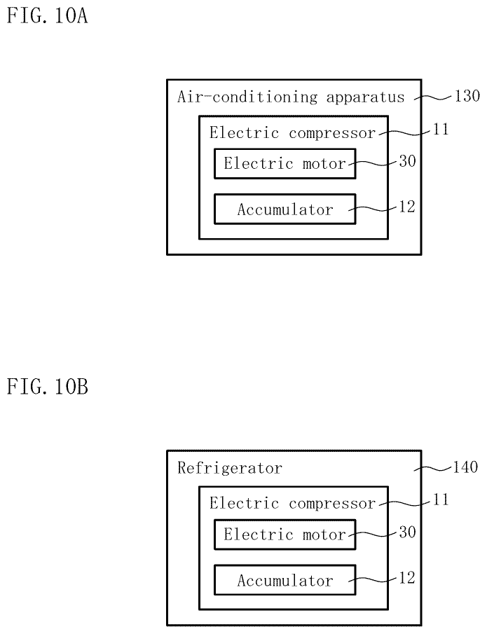

For example, a case where the electric compressor 11 having the cluster block 70, 100, 110, 120 is mounted to the vehicle 1, has been described. However, the present invention is not limited thereto. As shown in FIG. 10A, the electric compressor 11 having the cluster block 70, 100, 110, 120 may be mounted to an air-conditioning apparatus 130 for sending cool air to a room of a building and the like. The air-conditioning apparatus 130 generates cool air by the electric compressor 11 that mainly includes the electric motor 30 and the accumulator 12, similarly to the air-conditioning apparatus 10 described above in the embodiments.

As shown in FIG. 10B, the electric compressor 11 having the cluster block 70, 100, 110, 120 may be mounted to a refrigerator 140. The refrigerator 140 generates cool air by the electric compressor 11 that mainly includes the electric motor 30 and the accumulator 12, and cools the inside of the refrigerator by the cool air, similarly to the air-conditioning apparatus 10 described above in the embodiments.

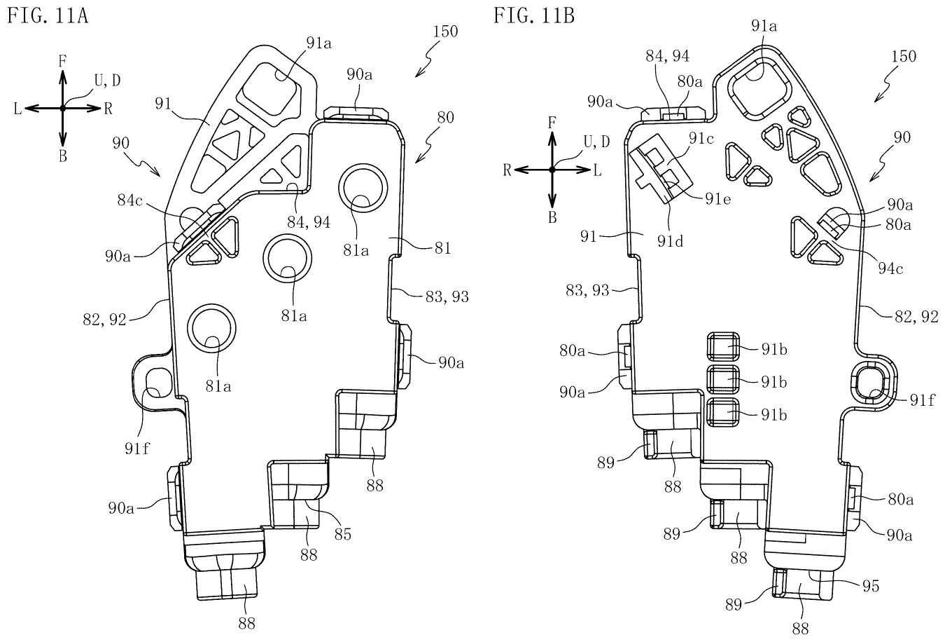

In the above-described first embodiment, the first through hole 91a is displaced rearward in the circumferential direction from the front surface position of the regulation surface 91e. However, the present invention is not limited thereto. For example, the first through hole 91a may be displaced forward in the circumferential direction from the front surface position of the regulation surface 91e. Furthermore, as shown in FIG. 11A and FIG. 11B, a cluster block 150 in which the first through hole 91a is disposed in front of the regulation surface 91e may be configured. In both a case where the first through hole 91a is disposed in front of the regulation surface 91e and a case where the first through hole 91a is displaced from the front surface position of the regulation surface 91e, the regulation surface 91e is defined as facing toward the first through hole 91a.

In FIG. 11A and FIG. 11B, as in FIG. 3, almost all of the ridge lines of the components of the cluster block 150 are shown. The cluster block 150 basically has almost the same configuration as the cluster block 70 of the first embodiment except that a portion protruding outward of the second outer wall 94 in the second plate portion 91 is extended forward in the circumferential direction, in the cluster block 150. In the outward protruding portion, a plurality of holes in addition to the first through hole 91a are formed so as to penetrate, or a plurality of stepped portions are formed, whereby the weight of the second plate portion 91 is reduced. Two recesses that are recessed upward along the regulation surface 91e are disposed at the lower end of the adjusting protrusion 91c of the cluster block 150, and the adjusting protrusion 91c is formed in an E-like shape to reduce the weight. The numbers or the shapes of the plurality of holes, stepped portions, and recesses may be changed as appropriate, and the holes, the stepped portions, and the recesses may be applied to the cluster block 70 and the like.

In the cluster block 150, the adjusting protrusion 91b is divided into three portions in the front-rear direction as compared with the cluster block 70. The number of the adjusting protrusions 91b of the cluster block 150 may be one, two, or four or more, and the adjusting protrusion 91b of the cluster block 70 or the like may be divided into two or more portions in the front-rear direction. The position of the protrusion 45 is changed to a position at which the protrusion 45 can be inserted into the first through hole 91a from the position in the first embodiment, in the bobbin 42 to which the cluster block 150 is mounted.

In the above-described embodiments, in the cluster block 70, 100, 110, 120, 150, the three individual spaces S1 to S3 are formed. For example, the number of the individual spaces may be one, two, or four or more. The number of the individual spaces is made equal to the number of the connection terminals 61 to 63 disposed at the ends of the motor wires 51 to 53 extracted from the electric motor 30. The number of the inner wall portions for separating the individual spaces may be one, or three or more according to the number of the individual spaces, and the number of the connection holes (connecting grooves 85c, 95c), the number of the end surfaces 85a, 95a, the number of the extension portions 88, 111, and the like may be changed as appropriate.

In the above-described embodiments, the cluster block 70, 100, 110, 120, 150 is divided into two members at the division surfaces P1, P2. However, the cluster block 70, 100, 110, 120, 150 may be formed of one member, or three or more members. In a case where the cluster block 70, 100, 110, 120, 150 is formed of one member, the extension portions 88, 111, the regulation portions 89, 115, the first regulation portions 121, and the second regulation portions 122 for inhibiting the covering portions 51b to 53b and the like from being caught by the division surfaces P1, P2 may be omitted. In a case where the cluster block 70, 100, 110, 120, 150 is formed of one member, the inner wall portions for separating the individual spaces S1 to S3 may be each integrated with the first plate portion 81 and the second plate portion 91, and thus, the inner wall portions may not necessarily be formed by overlapping of the first inner walls 86, 87 and the second inner walls 96, 97.

In the above-described embodiments, the regulation surface 91e of the wall portion 91d faces outward in the radial direction, and the projection 46 projects outward from the protrusion 45 in the radial direction. However, the present invention is not necessarily limited thereto. As long as the direction in which the regulation surface 91e faces and the direction in which the projection 46 projects from the protrusion 45 are the same as viewed in the up-down direction, the directions may be the radially inward direction, the circumferential direction, or the like. The direction in which the regulation surface 91e faces and the direction in which the projection 46 projects from the protrusion 45 are defined as being the same not only in a case where the linear line that is almost perpendicular to the regulation surface 91e, is parallel to the linear line passing through the center of the projection 46 in the width direction (circumferential direction) as viewed in the up-down direction, but also in a case where these linear lines are slightly deviated from the parallel state (for example, at 10°).

The positions of the wall portion 91d, the first through hole 91a, 102, the second through hole 91f, and the like may be changed as appropriate. According to the change, the positions of the contact surface 42f, the protrusion 45, and the insertion portion 47 may be changed. For example, the contact surface 42f may not necessarily be the inner circumferential wall surface of the inner circumferential wall portion 42c, and the contact surface 42f may be the inner circumferential wall surface or the outer circumferential wall surface of the outer cylindrical wall portion 42a. When the outer circumferential wall surface of the outer cylindrical wall portion 42a is the contact surface 42f, the surface of the wall portion 91d on the inner side in the radial direction is the regulation surface 91e.

In the above-described embodiments, the projection length L1 of the projection 46 is half or more the thickness L2 of the protrusion 45 in the first through hole 91a, and the length of the first through hole 91a in the projecting direction of the projection 46 is larger than the total of the projection length L1 and the thickness L2. However, the dimensional relationship may be changed as appropriate.

In the above-described embodiments, the inner wall portions for separating the individual spaces S1 to S3 from each other are formed by partial overlapping of the first inner walls 86, 87 and the second inner walls 96, 97. However, the present invention is not necessarily limited thereto. The first inner walls 86, 87 may be formed over the entire length from the first outer wall 84 to the first outer wall 85 in the front-rear direction, and the entirety of the inner wall portions may be formed by overlapping of the first inner walls 86, 87 and the second inner walls 96, 97. For example, in this case, the insulating distance between the linking portions 61c to 63c and the insulating distance between the connection portions 62a, 63a and the linking portions 61c, 62c can be further increased.

In a case where a necessary insulating distance between the connection terminals 61 to 63 can be ensured, the position at which overlapping of the first inner walls 86, 87 and the second inner walls 96, 97 is omitted may be changed as appropriate. For example, by changing the shapes (height relationship) of the components of the connection terminals 61 to 63 as appropriate, and changing the necessary insulating distance therebetween, the position at which the first inner walls 86, 87 and the second inner walls 96, 97 are required to overlap may be changed. In a case where, for example, a part of the connection terminals 61 to 63 is recessed upward, the first member 80 described above may be set as the second member, the second member 90 described above may be set as the first member, and the first inner walls of the first member after the change may be partially omitted so as to correspond to the position at which the connection terminals 61 to 63 are recessed upward.

In the above-described embodiments, the individual spaces S1 to S3 are displaced from each other in the front-rear direction. However, the present invention is not necessarily limited thereto. The front ends or the rear ends of the individual spaces S1 to S3 may be aligned, or the displacement manner may be changed as appropriate. The inner wall portions between the connection portions 61a to 63a may be formed by overlapping of the first inner walls 86, 87 and the second inner walls 96, 97, or may be formed merely by the second inner walls 96, 97, according to the necessary insulating distance between the connection portions 61a to 63a. In a case where the rear ends of the individual spaces S1 to S3 are aligned, the end surfaces 85a around the three connection holes (connecting grooves 85c, 95c) are also aligned as one surface.

In the above-described embodiments, the three extension portions 88 in total protrude from the end surfaces 85a around the three connection holes, respectively, and the three extension portions 111 in total protrude from the end surfaces 95a around the three connection holes, respectively. However, the present invention is not limited thereto. For example, one or two extension portions 88 may protrude from the end surfaces 85a around one or two of the three connection holes, and one or two extension portions 111 may protrude from the end surfaces 95a around one or two of the three connection holes. This applies to both a case where the end surfaces 85a around the three connection holes are aligned as one surface, and a case where the end surfaces 85a are separate for each connection hole.

In the above-described embodiments, the division surfaces P1, P2 of the first member 80 and the second member 90 are displaced downward (toward the second member 90 side) of the axes of the motor wires 51 to 53 stored in the connecting grooves 85c, 95c. However, the present invention is not necessarily limited thereto. The division surfaces P1, P2 may pass through the axes of the motor wires 51 to 53, or the division surfaces P1, P2 may be displaced upward (toward the first member 80 side) of the axes. In a case where the division surfaces P1, P2 are disposed upward of the axes, the first member 80 having the insertion holes 81a may be set as the second member, and the second member 90 on the bobbin side may be set as the first member. The upper side and the lower side of the cluster block 70, 100, 110, 120, 150 may be inverted, and the second member 90 on the upper side may have the insertion holes 81a. The first outer walls 82 to 85 or the second outer walls 92 to 95 may be omitted depending on the positions of the division surfaces P1, P2.

### DESCRIPTION OF REFERENCE NUMERALS

10 air-conditioning apparatus (on-vehicle apparatus)
11 electric compressor
20 compressing portion
30 electric motor
41 stator core
41a axial end surface (of stator core)
42 bobbin
42d, 42e axial end surface (of bobbin)
42f contact surface
43 coil
45 protrusion
46 projection
47 insertion portion
51, 52, 53 motor wire
56 control circuit
61, 62, 63 connection terminal
70, 100, 110, 120, 150 cluster block
91 second plate portion (bottom plate)
91a, 102 first through hole
91d wall portion
91e regulation surface
91f second through hole
103 hook portion
130 air-conditioning apparatus
140 refrigerator

What is claimed is:

1. A cluster block fixing structure for mounting a cluster block to an electric motor in an electric compressor that includes a compressing portion for compressing a fluid, the electric motor for driving the compressing portion, a control circuit for performing drive control of the electric motor, a motor wire extracted from the electric motor, a connection terminal disposed at an end of the motor wire and electrically connected to the control circuit, and an insulating cluster block for storing the connection terminal, wherein
the electric motor includes a cylindrical bobbin which is disposed on an axial end surface of a cylindrical stator core and around which a coil is wound,
the cluster block includes
a bottom plate having a bottom surface in contact with an axial end surface of the bobbin on an opposite side to the stator core side,
a first through hole penetrating through the bottom plate in an axial direction of the bobbin, and
a wall portion having a regulation surface facing toward the first through hole, the wall portion extending toward the stator core from the bottom surface,
the bobbin includes
a protrusion protruding from the axial end surface of the bobbin, the protrusion being inserted into the first through hole,
a projection projecting from an end of the protrusion in a direction that is the same as a direction in which the regulation surface faces, and
a contact surface coming into contact with the regulation surface, and
a part of the bottom plate around the first through hole and the projection oppose each other in the axial direction in a state where the contact surface is in contact with the regulation surface.

2. The cluster block fixing structure according to claim 1, wherein
the contact surface is an inner circumferential wall surface facing inward in a radial direction in the bobbin, and
the motor wire extending from the cluster block is curved along a circumferential direction of the bobbin.

3. The cluster block fixing structure according to claim 1, wherein a projection length of the projection from the protrusion to an end of the projection is half or more a thickness in dimensions of the protrusion in the first through hole in a projecting direction of the projection.

4. The cluster block fixing structure according to claim 1, wherein
the cluster block includes a second through hole penetrating through the bottom plate in the axial direction at a position which is distant from the first through hole in a direction perpendicular to the projecting direction of the projection, and
the bobbin includes an insertion portion that protrudes from the axial end surface of the bobbin and that is inserted into the second through hole.

5. The cluster block fixing structure according to claim 4, wherein
the contact surface is an inner circumferential wall surface facing inward in a radial direction in the bobbin,
the motor wire extending from the cluster block is curved along a circumferential direction of the bobbin, and
the bottom plate around the first through hole is formed by a hook portion by opening a part of the first through hole on an outer side in the radial direction at an edge of the bottom plate on an outer side in the radial direction.

6. An electric motor to which the cluster block is mounted by the cluster block fixing structure according to claim 1.

7. An electric compressor comprising:
the cluster block fixing structure according to claim 1;
the compressing portion;
the electric motor;
the control circuit;
the motor wire;
the connection terminal; and
the cluster block.

8. An air-conditioning apparatus comprising the electric compressor according to claim 7.

9. A refrigerator comprising the electric compressor according to claim 7.

10. An on-vehicle apparatus comprising the electric compressor according to claim 7.
